(19) United States
(12) Patent Application Publication
(10) Pub. No.: US 2006/0215887 A1
(43) Pub. Date: Sep. 28, 2006

(54) Authentication apparatus employing image, method of authentication, authentication program product, and storage medium having the program stored therein

(75) Inventors: Koichi Nishimura, Osaka (JP); Masafumi Yashiki, Nara (JP); Takahiko Nakano, Ikoma-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 11/375,091

(22) Filed: Mar. 15, 2006

(30) Foreign Application Priority Data
Mar. 16, 2005 (JP) 2005-075525

(51) Int. Cl. G06K 9/00

(52) U.S. Cl. 382/124

(57) ABSTRACT

In an enrollment mode a parameter value applied when a fingerprint pickup picks up an image of a fingerprint to be enrolled is stored to a non-volatile memory in association with image data. In an authentication mode the parameter value is read and set in the fingerprint pickup and a fingerprint is thus picked up. When an authentic, enrolled person undergoes fingerprint authentication a parameter value that matches an individual characteristic of the person is applied to pick up a fingerprint, and an image having a level of quality sufficient for authentication can be obtained. If a person other than an authentic, enrolled person undergoes fingerprint authentication, a parameter value that does not match an individual characteristic of the person is applied to pick up a fingerprint and an image signal is output, and this image signal cannot provide an image having sufficient quality. Only the image of the authentic, enrolled person can provide image quality sufficient for authentication.

This nonprovisional application is based on Japanese Patent Application No. 2005-075525 filed with the Japan Patent Office on Mar. 16, 2005, the entire contents of which are hereby incorporated by reference.

### BACKGROUND OF THE INVENTION

1. Field of the Invention

The present invention relates generally to authentication apparatuses employing images, authentication methods, authentication program products and storage media having the program stored therein, and particularly to those which change a parameter value associated with pickup for obtaining image data of an object to be authenticated.

2. Description of the Background Art

Conventionally when authentication is required to determine whether an individual matches an enrolled individual (or an authentic person) a personal identification number (PIN) or the like is employed for the authentication. In recent years, however, fingerprint is increasingly utilized in authentication. In fingerprint authentication a fingerprint authentication apparatus having fingerprint images previously enrolled therein is provided. In authentication, a fingerprint image of a person to be authenticated that is obtained by a fingerprint pickup device incorporated in the apparatus is compared with a previously enrolled fingerprint image and from a result thereof whether a person to be authenticated is identical to a person having a fingerprint enrolled (hereinafter also referred to as an “enrolled person”) is determined. If a decision is made that the fingerprint is that of the same person, the authentication is successfully done, otherwise, the authentication fails.

In contrast to PIN authentication apparatuses, fingerprint authentication is devoid of lost and leaked PINs. Accordingly it is utilized in systems for which security is important.

In recent years as settlement systems via the Internet or similar communication networks have widely been utilized, fingerprint authentication devices are increasingly incorporated in mobile phones, personal digital assistant (PDA) and other similar personal mobile equipment. For such personal mobile equipment a fingerprint authentication device employing a solid state image sensing device to pick up an image of a fingerprint is used as it can help miniaturization.

When a solid state image sensing device is used to pick up an image of a fingerprint, a finger is placed on a pickup surface of the device in close contact therewith and thus picked up thereby. Different persons have their respective fingers with different amounts of sebum thereon and also push the pickup surface with their fingers with different magnitudes of force. This disadvantageously affects images in quality.

To overcome such disadvantage a variety of proposals have been suggested. For example, Japanese Patent Laying-Open No. 2003-187234 proposes measuring a value in resistance of an object on a pickup surface and employing the obtained value to modify a parameter of the pickup device to provide an image improved in quality.

Furthermore Japanese Patent Laying-Open No. 2004-199487 proposes that a pressure sensor is provided under a pickup surface and in picking up an image when the pickup surface receives a specific magnitude of force, picking up the image is started so as to pick up an image improved in quality.

In the above documents a pickup device has a parameter automatically modified in response to a characteristic of an object placed on a pickup surface or when an object placed on the pickup surface presents a characteristic having a specific level an image can be picked up to obtain an image having good quality. As such, if an unenrolled person places his/her finger on the pickup surface and its fingerprint is picked up, the picked up image is satisfactory in quality, as well as a picked up image of a fingerprint an enrolled person.

Enhancing an image of a fingerprint of an unenrolled person in quality contributes to an increased False Acceptance Rate (FAR), i.e., rate of erroneously recognizing a third person who is not an authentic, enrolled person as an authentic, enrolled person, and may impair security employing finger authentication. Accordingly it is desirable in terms of security that while an authentic, enrolled person's fingerprint is picked up in an image having good quality, an inauthentic, unenrolled person's fingerprint is not picked up in an image having good quality.

### SUMMARY OF THE INVENTION

The present invention contemplates an authentication apparatus, authentication method, authentication program product and storage medium having the program stored therein that can provide an object pickup process so that of objects to be authenticated, an object alone that is to be enrolled is picked up in an image with the object's unique value applied to a parameter.

In order to achieve the above object the present invention in one aspect provides an authentication process in which in accordance with a received parameter value a pickup picks up an image of an object and an image signal of the object is output and converted to image data, and in an enrollment mode a parameter value is determined, as based on the output image data, and associated with the output image data for storage.

In an authentication mode the stored parameter value is read and provided to the pickup, and image data stored in association with the read parameter is compared with the output image data.

In the present invention in the enrollment mode a parameter value of the pickup that is applied in picking up an image of an object is stored. If in the authentication mode an object is picked up in an image to obtain image data, the parameter value determined in the enrollment mode for the object picked up is provided to the pickup and the object is thus picked up in the image. Thus in the authentication mode when an object identical to that is picked up in the enrollment mode is subjected to authentication, a parameter value previously determined and enrolled for the object is applied to pick up an image of the object.

If an object that is not identical to that picked up in an image in the enrollment mode is subjected to authentication, a parameter value that is not determined for the object is applied to pick up an image of the object. Only when an enrolled object is picked up in an image, a parameter value unique to the object can be used to pick up the image. As a result, image data compared indicates a different fingerprint. The authentication process can thus provide a result with a reduced FAR, and hence enhanced security.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a configuration of a fingerprint authentication apparatus in each embodiment.

FIG. 2 is a block diagram of a capacitive fingerprint pickup.

FIG. 3 shows a sensor electrode unit having a pickup surface with a finger placed thereon.

FIG. 4 is a block diagram of a fingerprint pickup employing a piezoelectric sensor.

FIG. 5 is a block diagram of a fingerprint pickup employing an optical sensor.

FIG. 6 shows an external appearance of a mobile phone in a first embodiment.

FIG. 7 is a schematic process flow chart in the first embodiment.

FIG. 8 is a flow chart of a fingerprint enrollment process in the first embodiment.

FIG. 9 is a flow chart of a fingerprint pickup process in the first embodiment.

FIG. 10 illustrates enrolled fingerprint data in the first embodiment.

FIG. 11 is a flow chart of a fingerprint authentication process in the first embodiment.

FIG. 12 generally shows a server computer in a second embodiment.

FIG. 13 illustrates enrolled fingerprint data in the second embodiment and a third embodiment.

FIG. 14 is a general process flow chart in the second embodiment.

FIG. 15 is a flow chart of a fingerprint enrollment process in the second embodiment.

FIG. 16 is a flow chart of a fingerprint authentication process in the second embodiment.

FIG. 17 is a general process flow chart in the third embodiment.

FIG. 18 is a flow chart of a fingerprint authentication process in the third embodiment.

### DESCRIPTION OF THE PREFERRED EMBODIMENTS

Hereinafter the present invention in embodiments will be described with reference to the drawings. As described herein, an object's information to be picked up in an image for personal authentication is biometrics information unique to the individual and is herein an image of a fingerprint, although it is not limited thereto. For example, it may be images of retina, veins and the like. Herein a process employing fingerprint to authenticate an individual will be referred to as a fingerprint authentication process.

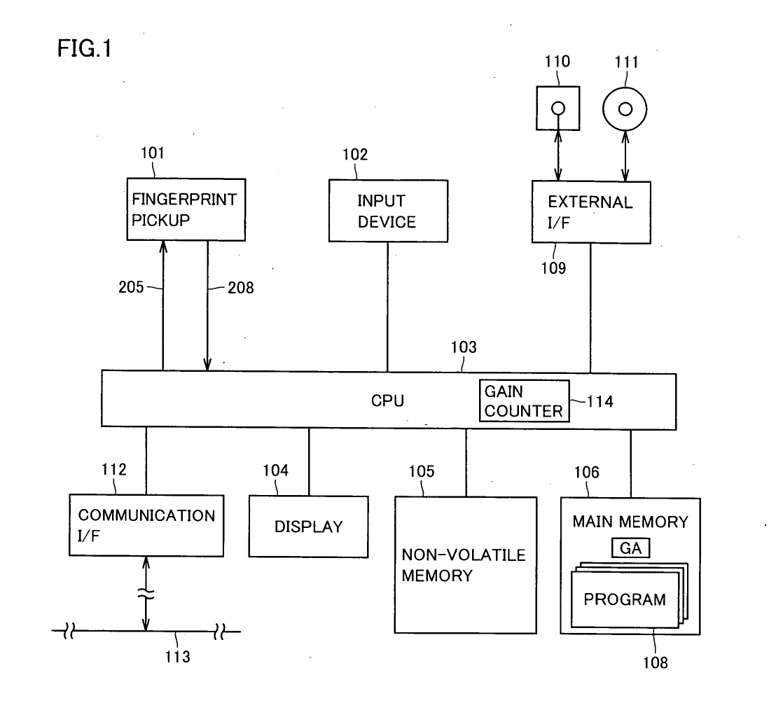

FIG. 1 shows a fingerprint authentication apparatus in accordance with each embodiment including a fingerprint pickup 101, an input device 102, a central processing unit (CPU) 103 having a gain counter 114 as described hereinafter, a display 104, a non-volatile memory 105, a main memory 106, an external interface (I/F) 109 attachably and detachably receiving a flexible disk (FD) 110, a compact disk read only memory (CD-ROM) 111 or the like to access the attached storage medium, and a communication I/F 112 for connecting a variety of external communication networks 113 and fingerprint authentication apparatus 1. Communication network 113 may be the Internet. Furthermore, it is not limited to a wired network, and may be a radio-wave, optical or similar, wireless communication network 113.

Fingerprint authentication apparatus 1 picks up an image of a fingerprint of a finger placed on a pickup surface of fingerprint pickup 101 in contact therewith, converts the picked up, obtained image signal to digital data, and outputs image data 208. Furthermore, fingerprint pickup 101 is provided with a pickup parameter variably set, and this set parameter modifies in quality a fingerprint image picked up and output. Herein the parameter is indicated as a gain control signal 205 for adjusting in gain an amplifier (not shown) of fingerprint pickup 101. One example of fingerprint pickup 101 is a capacitive fingerprint pickup device, as described for example by Kawasaki and Machida in “Fingerprint Sensor LSI” (The Institute of Electronics, Information and Communication Engineers, Technical Report of IEICE, CAS2002-25, VLD2002-39, DSP2002-65 (2002-06)). The document describes a fingerprint sensor including a pixel array and peripheral circuitry including an analog/digital converter. Each pixel includes a sensor electrode, a sensor circuit, a voltage-time conversion circuit, and an image noise correction calibration circuit.

Input device 102 is a device operated by a user of fingerprint authentication apparatus 1 to input desired information such as a fingerprint enrollment process, a fingerprint authentication process and other similar process modes, an ID (identification) number, and the like, and is implemented by a keyboard, a button and/or the like. CPU 103 generally controls and monitors fingerprint authentication apparatus 1 as well as performs all arithmetic operation processes. Display 104 includes a liquid crystal display, a cathode ray tube (CRT), a light emitting diode (LED) and the like and displays a variety of types of information including a result of the fingerprint enrollment process or the fingerprint authentication process. Non-volatile memory 105 stores one or more items of enrolled fingerprint data 107 as described hereinafter.

Main memory 106 has stored therein a variety of programs 108 for controlling and monitoring the operation of fingerprint authentication apparatus 1, and a variety of data including initial gain data GA as described hereinafter.

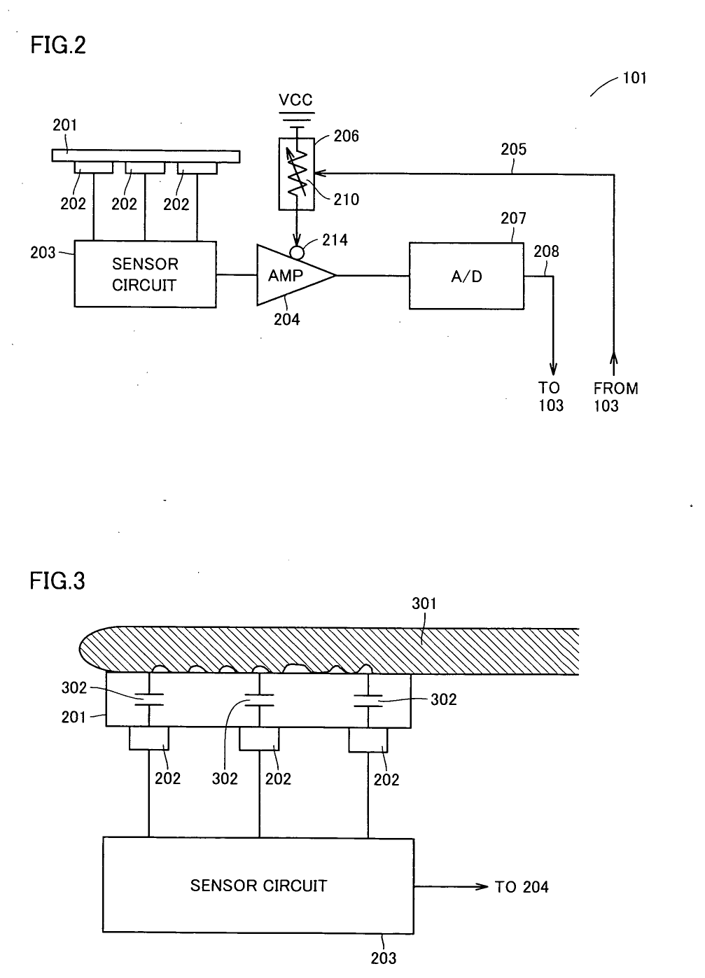

With reference to FIG. 2, fingerprint pickup 101 includes a pickup surface 201, a plurality of sensor electrodes 202, a sensor circuit 203, an amplifier 204 having a gain control terminal 214, a variable resistor 206 receiving gain control signal 205 from CPU 103, and an analog/digital (A/D) converter 207. Pickup surface 201 has a main surface (or an externally exposed surface) receiving a finger to be picked up in an image. The plurality of sensor electrodes 202 is arranged on a surface of pickup surface 201 that is opposite to the main surface of pickup surface 201. Sensor circuit 203 is configured as will be described later.

Amplifier 204 receives a voltage signal indicating an image signal output from sensor circuit 203, amplifies the received signal in accordance with a level in voltage of gain control terminal 214, and outputs the amplified signal.

Variable resistor 206 is connected to a constant voltage source VCC, and gain control terminal 214 receives voltage from constant voltage source VCC via variable resistor 206. Variable resistor 206 has a resistive element and a movable piece 210 moving on the resistive element in accordance with a level of gain control signal 205 applied. Thus the level of gain control signal 205 determines the position of movable piece 210 on the resistive element and variable resistor 206 accordingly varies in resistance. As such, the level of the voltage supplied from constant voltage source VCC to gain control terminal 214, i.e., the level of the gain of amplifier 204 is variably adjusted as CPU 103 modifies gain control signal 205 in level.

As amplifier 204 has a gain variably adjusted in level, amplifier 204 receives a voltage signal, increases and decreases the signal's direct current (dc) component (or an image's brightness signal) in level in accordance with the gain's level (or renders it brighter and darker) or the like, and outputs it. This means that a fingerprint image has each pixel varied in brightness.

A/D converter 207 receives an image signal output from amplifier 204, converts the received signal to digital data, or binary data based on a level in brightness, and outputs the obtained, converted data as image data 208 to CPU 103. The digital data output from A/D converter 207 is data indicating a level in brightness of each pixel of a fingerprint image. Thus fingerprint pickup 101 can pick up a gray-scale image. CPU 103 sets gain control signal 205 in level in accordance with image data 208 received and outputs gain control signal 205 set in level.

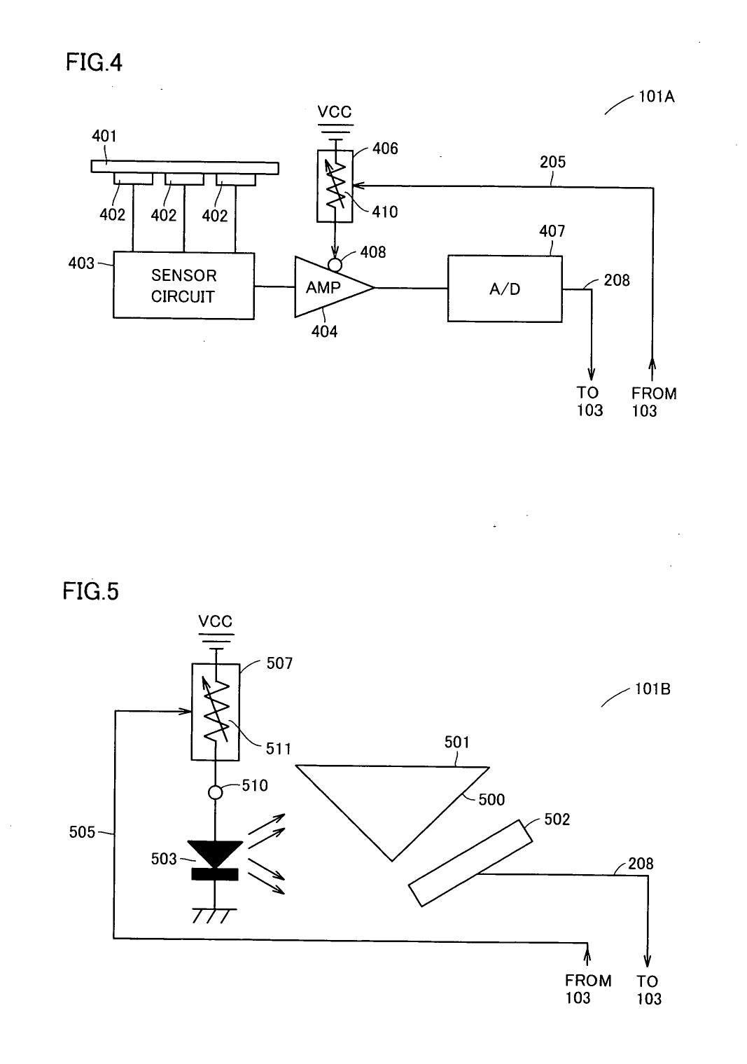

FIG. 3 diagrammatically shows a vicinity of the plurality of sensor electrodes 202 with a finger to be picked up 301 placed on the main surface of pickup surface 201. When finger 301 is placed on the main surface of pickup surface 201, a capacitor 302 is formed between each sensor electrode 202 and finger 301. As finger 301 has a fingerprint having protrusions and depressions, finger 301 and each sensor electrode 202 provide different distances therebetween and accordingly each capacitor 302 provides different capacitance. Sensor circuit 203 detects a difference in capacitance of each capacitor 302 from a level in voltage output from electrode 202, converts the detected difference to a voltage signal indicating that difference, and outputs the converted voltage signal to amplifier 204. Thus sensor circuit 203 outputs a voltage signal indicating a signal corresponding to an image indicating the protrusions than depressions of the finger placed on the main surface of pickup surface 201. FIG. 3 shows a capacitive sensor, and to sensor circuit 203, FIG. 4 in “Mounting Fingerprint Sensor in Mobile Equipment Takes Off”, EDN Japan 2002, 9 (http://www.ednjapan.com/edn_j/2002/09/cover0209.html) or the like is applicable. As shown in the figure, a circuit integrated in a chip controls two switches to alternately close to electrically charge a capacitor and the number of charging cycles elapsing before the capacitor attains a potential is employed to determine a fingerprint's ridges and troughs.

When CPU 103 performs a fingerprint comparison process for an input image data 208 in accordance with main program 108, CPU 103 compares the finger in accordance with a fingerprint line pattern. As such, if no fingerprint line is recognized, i.e., if a fingerprint provides image data 208 failing to distinguish the finger's ridges and troughs, the process fails. As such, if a fingerprint image is that of an authentic, enrolled person and despite that its brightness biases to be high or low, then the finger's ridges and troughs cannot be distinguished and the process fails. To prevent this, amplifier 204 has a gain adjusted in level. Generally, if a person having dry skin has his/her fingerprint picked up, the fingerprint provides an image having pixels high in brightness (or a bright image). Accordingly, amplifier 204 is controlled to have a reduced gain to provide reduced brightness (or a darker image). In contrast, if a person having oily skin has his/her fingerprint picked up, the fingerprint provides an image low in brightness (or a darker image). Accordingly, amplifier 204 is controlled to have an increased gain to provide increased brightness (or a brighter image). This can output image data 208 provided by a fingerprint image that does not have each pixel biasing to be high or low in brightness.

In FIG. 2, fingerprint pickup 101 is implemented by a capacitive sensor. Alternatively, it may be a fingerprint pickup 101A employing a piezoelectric sensor shown in FIG. 4 or a fingerprint pickup 101B employing an optical sensor shown in FIG. 5. Fingerprint pickup 101A employing the piezoelectric sensor shown in FIG. 4 includes a pickup surface 401, a plurality of piezoelectric sensor electrodes 402, a sensor circuit 403, an amplifier 404 having a gain control terminal 408, a variable resistor 406 receiving a gain control signal 205, and an A/D converter 407.

Pickup surface 401 has an externally exposed, main surface receiving a finger to be picked up in an image. The plurality of piezoelectric sensor electrodes 402 is arranged on a surface of pickup surface 401 that is opposite to the main surface of pickup surface 401. Piezoelectric sensor electrode 402 and sensor circuit 403 are configured and function as specifically described in Japanese Patent Laying-Open No. 05-061966. As disclosed in the publication, a fingerprint sensor is configured of a plurality of sensor devices arranged in a matrix. The sensor device has a bottom electrode provided with a piezoelectric conductive film thereon and on the film a top electrode is provided to recede at least by a dimension corresponding to half the thickness of the film, and via the top and bottom electrodes a polarization process is performed. The fingerprint sensor is thus provided.

Amplifier 404 receives a voltage signal indicating an image signal output from sensor circuit 403, amplifies the received signal in accordance with a level in voltage of gain control terminal 408, and outputs the amplified signal.

Variable resistor 406 is connected to constant voltage source VCC, and gain control terminal 408 receives voltage from constant voltage source VCC via variable resistor 406. Variable resistor 406 has a resistive element and a movable piece 410 moving on the resistive element in accordance with a level of gain control signal 205 applied from CPU 103. Thus the level of gain control signal 205 determines the position of movable piece 410 on the resistive element and variable resistor 406 accordingly varies in resistance. As such, the level of the voltage supplied from constant voltage source VCC to gain control terminal 408, i.e., the level of the gain of amplifier 404 is variably adjusted as CPU 103 modifies gain control signal 205 in level.

A/D converter 407 receives an image signal output from amplifier 404, converts the received signal to digital data, and outputs the converted signal as image data 208 to CPU 103. CPU 103 sets gain control signal 205 in level in accordance with image data 208 received and outputs gain control signal 205 set in level.

Piezoelectric sensor electrode 402 detects pressure exerted by an object placed on pickup surface 401 and sensor circuit 403 converts the detected pressure to a voltage signal and outputs the voltage signal. The output voltage signal, which is an image signal, is amplified by amplifier 404 and then converted by A/D converter 407 to digital data. A/D converter 407 outputs the digital data, which indicates brightness of each pixel of a fingerprint image. A fingerprint at a ridge presses pickup surface 401 with a magnitude of pressure and at a trough does so with a different magnitude of pressure. Accordingly A/D converter 407 outputs digital data varying between the ridge and the trough. Accordingly pixels corresponding to the ridge and the trough, respectively, provide different levels of brightness.

The pressure applied to pickup surface 401 varies between individuals. Accordingly, picked up and thus obtained fingerprint images reflect individual differences in brightness and can bias to be high or low in brightness. In such a case, even an authentic, enrolled person cannot have his/her fingerprint distinguished between ridge and trough and the fingerprint comparison process fails. Accordingly, as described for the FIG. 2 capacitive fingerprint pickup, the FIG. 4 configuration also has CPU 103 controlling a gain of amplifier 404 in level by gain control signal 205 to output image data 208 unbiased to be high or low in brightness.

Reference will now be made to FIG. 5 to describe fingerprint pickup 101B employing an optical sensor. A fingerprint pickup employing an optical sensor is configured, as described specifically in Japanese Patent Laying-Open No. 11-309133. Accordingly, herein it will be described briefly. The publication discloses an optical fingerprint reader including an optical surface with a fingerprint or similar pickup surface abutting thereagainst, a source of light emitting light to illuminate the optical surface, pickup means reading an image from the pickup surface, and a display the image or a result of processing the image. FIG. 5 shows a configuration adjusting an amount of light of a source of light for illumination in picking up a fingerprint to obtain an appropriate fingerprint image.

With reference to FIG. 5, fingerprint pickup 101B employing the optical sensor includes a prism 500 having a pickup surface 501 receiving thereon a finger to be picked up in an image, a charge coupled device (CCD) camera 502 for picking up a fingerprint, a light emitting diode (LED) 503, and a variable resistor 507 receiving a signal 505 indicating an image quality adjustment parameter and applied to control light in quantity. LED 503 emits light, which is turn received by and enters prism 500, and illuminates the finger placed on pickup surface 501.

CCD camera 502 utilizes the light emitted from LED 503 and thus picks up an image of a fingerprint of the finger placed on pickup surface 501. A fingerprint image is thus picked up, and digital data corresponding thereto, or image data 208 is output to CPU 103. Based on image data 208, CPU 103 generates and outputs signal 505. CCD camera 502 performs a pickup operation as controlled by CPU 103.

Variable resistor 507 is connected to constant voltage source VCC, and LED 503 has an input terminal 510 receiving voltage from constant voltage source VCC via variable resistor 506. Variable resistor 506 has a resistive element and a movable piece 511 moving on the resistive element in accordance with a level of signal 505 applied. Thus the level of signal 505 determines the position of movable piece 511 on the resistive element and variable resistor 506 accordingly varies in resistance. As such, the level of the voltage supplied from constant voltage source VCC via input terminal 510 to LED 503, i.e., that of a forward current supplied to LED 503, is variably adjusted as CPU 103 adjusts signal 505 in level.

When LED 503 receives a current higher in level it emits a larger quantity of light. If it receives a current lower in level, it emits a smaller quantity of light. As such, LED 503 emits light in a quantity variably adjusted by a level of a current supplied in accordance with a level in voltage of terminal 510, i.e., a level of signal 505.

CPU 103 can thus control in level signal 505 adjusting a quantity of light in place of a gain control signal 205 to adjust a quantity of light of LED 503, i.e., that of light for illumination in picking up an image of a fingerprint, and hence a dc component of a picked up and thus obtained image signal in level, i.e., each pixel's brightness in level.

While to the FIG. 1 fingerprint pickup 101 any of pickups employing a capacitor, a piezoelectric sensor and an optical sensor, respectively, is applicable, a solid state image sensing device employing a CCD may be used and a gain of a voltage signal corresponding to an image output from the device may variably be adjusted. In first to third embodiments described hereinafter the FIG. 2 capacitive fingerprint pickup 101 is used. Note that fingerprint authentication apparatus 1 has a mode of operation including an enrollment mode and an authentication mode.

### First Embodiment

In the present embodiment will be described a fingerprint authentication apparatus incorporated in an individually owned mobile phone or similar equipment requiring an authentication process for a fingerprint of a specific one person.

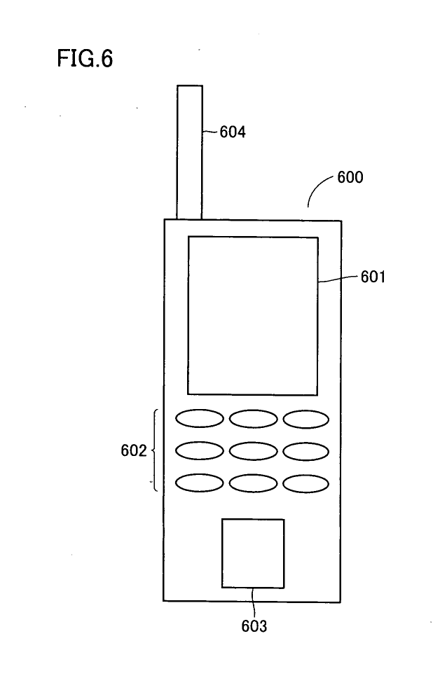

FIG. 6 schematically shows an external appearance of a mobile phone 600 in the first embodiment. Mobile phone 600 has CPU 103, non-volatile memory 105 and main memory 106 of fingerprint authentication apparatus 1 as shown in the FIG. 1 incorporated therein. Communication I/F 112 is substituted in function with wireless communication employing an antenna 604. FD 110 or CD-ROM 111 is substituted with a stick memory or the like (not shown) detachably attachable to mobile phone 600. Mobile phone 600 includes a liquid crystal display 601 corresponding to display 104, a numeral key 602 corresponding to input device 102, and a fingerprint pickup 603 corresponding to fingerprint pickup 101. Fingerprint pickup 603 is assumed to have a pickup surface externally exposed.

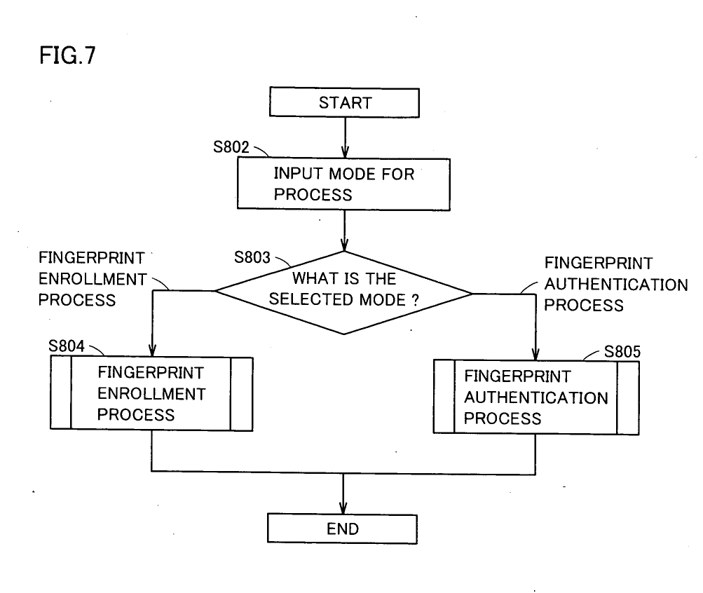

Mobile phone 600 has a program stored in main memory 106 for a communication function. The program is read and executed by CPU 103 to effect a phone call process. Starting a call entails fingerprint authentication and if the fingerprint authentication is successfully done the call is permitted for the sake of illustration. A process therefor has a procedure, as will be described with reference to the FIGS. 7-9 and 11 flow charts. These flow charts are previously stored in main memory 106 in the form of a program read and executed by CPU 103.

Initially the user of mobile phone 600 designates which of a fingerprint enrollment process and a fingerprint authentication process is performed. More specifically, with reference to FIG. 7, at S802 the user operates input device 102 to input information to select either the fingerprint enrollment process or the fingerprint authentication process to be performed. At S803 CPU 103 makes a decision based on the received information. More specifically, if CPU 103 determines that the received information indicates that the fingerprint enrollment process is selected CPU 103 proceeds to S804 to set the enrollment mode and perform the fingerprint enrollment process. If CPU 103 determines that the received information indicates that the fingerprint authentication process is selected CPU 103 proceeds to S805 to set the authentication mode and perform the fingerprint authentication process.

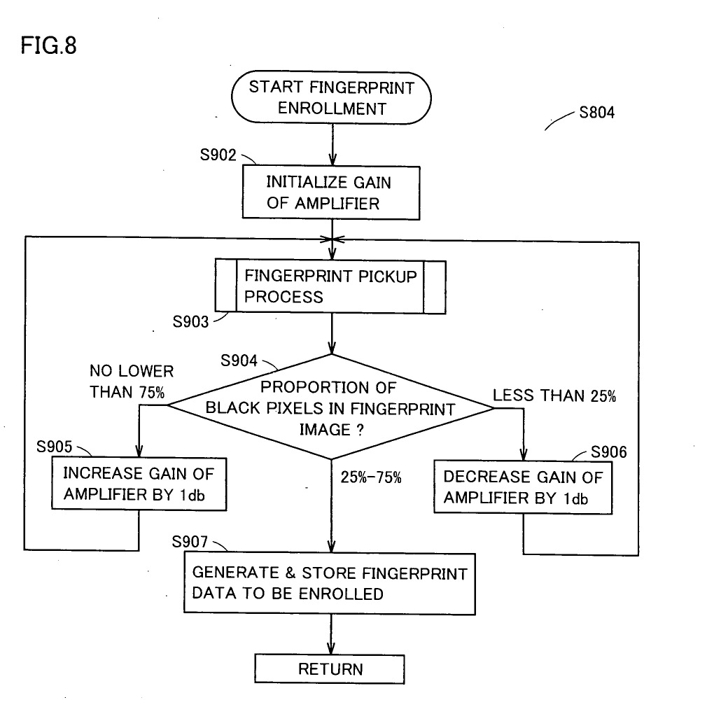

At S804 the fingerprint enrollment process is performed, as more specifically be described hereinafter with reference to the FIG. 8 flow chart. Note that the user's finger 301 is placed on pickup surface 201 and in picking up an image of a fingerprint the pickup surface is entirely covered with that side of a prescribed finger which is opposite to the finger nail.

Initially CPU 103 proceeds to S902 to initialize gain counter 114 in value. More specifically, CPU 103 reads initial gain data GA from main memory 106 and sets gain counter 114 to have a value indicated by initial gain data GA read. CPU 103 sets gain control signal 205 to have a level corresponding to the value of gain counter 114 and outputs gain control signal 205 thus set in level to variable resistor 206. Variable resistor 206 has movable piece 210 moved to a position corresponding to the level of gain control signal 205, and amplifier 204 has a gain having a level indicated by initial gain data GA.

At S903 CPU 103 instructs fingerprint pickup 101 to effect the fingerprint pickup process. This process will be described more specifically later. When this process ends, main memory 106 receives image data 208 of a fingerprint picked up in an image and temporarily stores the image data therein.

At S904 CPU 103 reads image data 208 stored in main memory 106 and makes a decision based on the read image data 208 as to whether the picked up and thus obtained image has a quality matching a prescribed condition for the comparison process. For the sake of simplicity, fingerprint pickup 101 provides an image having a gray scale represented by one bit. More specifically, the picked up image has only white and black pixels, i.e., two types of pixels. An image is determined in quality by CPU 103 counting the number of black pixels present in an image represented by image data 208 picked up at S903 and stored in main memory 106. If CPU 103 determines that the total number of black pixels occupies for example at least 75% of the total number of all of the pixels of the image, the image is too dark for the comparison process and accordingly CPU 103 proceeds to S905.

At S905 CPU 103 increases the total number of white pixels of image data 208 (or increases the picked up image's level in brightness). More specifically, amplifier 204 has the current gain increased in level by 1 db by incrementing gain counter 114 in value by one, setting gain control signal 205 to have a level indicated by the value of gain counter 114 incremented, and outputting to variable resistor 206 gain control signal 205 thus set in level. This moves movable piece 210 to a position indicated by the level of gain control signal 205 received. As a result gain terminal 214 of amplifier 204 has voltage increased in level and the amplifier thus has a gain increased by 1 db. Thereafter CPU 103 returns to S903 and again picks up an image of the fingerprint. Image data 208 of an image having an increased level in brightness is thus output.

If CPU 103 determines that the total number of black pixels is for example less than 25% of the total number of all of the pixels of the image (“25%” at S904), the image is too white (or bright) for the comparison process and accordingly CPU 103 proceeds to S906.

At S906 CPU 103 increases the total number of black pixels of image data 208 (or decreases the picked up image's level in brightness). More specifically, amplifier 204 has the current gain decreased in level by 1 db by decrementing gain counter 114 in value by one, setting gain control signal 205 to have a level indicated by the value of gain counter 114 decremented, and outputting to variable resistor 206 gain control signal 205 thus set in level. This moves movable piece 210 to a position indicated by the level of gain control signal 205 received. As a result gain terminal 214 of amplifier 204 has voltage decreased in level and the amplifier thus has a gain decreased by 1 db. Thereafter CPU 103 returns to S903 and again picks up an image of the fingerprint. Image data 208 of an image having a decreased level in brightness is thus output.

If neither one of the above two patterns applies, i.e., at S904 CPU 103 determines that the total number of black pixels is at least 25% and less than 75% (“25%-75%” at 904), a fingerprint image having a level in brightness that is appropriate for the comparison process has been picked up, and CPU 103 proceeds to S907. Thus if the total number of black pixels is at least 25% and less than 75% a decision is made that the picked up and thus obtained image has a quality matching a prescribed condition for the comparison process.

Thus fingerprint 301 is placed on pickup surface 201 and its fingerprint is picked up and output in an image, and until the image provides a quality that matches the prescribed condition, the fingerprint is repeatedly picked up. Whenever the fingerprint is picked up, main memory 106 has image data 208 updated (or overwritten) with image data output as the fingerprint is picked up.

At S907 CPU 103 reads data of a level in gain of amplifier 204 as indicated by gain control signal 205 currently output, i.e., the current value of gain counter 114, and reads image data 208 from main memory 106, and generates enrolled fingerprint data 107 including the read, current value of gain counter 114 and image data 208 as gain control level data 121 and fingerprint image data 122 and stores enrolled fingerprint data 107 to non-volatile memory 105, and returns to the FIG. 7 process. Therefore, gain control level data 121 indicates a gain value in accordance with characteristics of the person (the object) and circuits. FIG. 10 shows the data stored in non-volatile memory 105.

While for the S904 decision, ranges (or reference proportions) of 75% or higher, 25-75%, and 25% or lower, respectively, are set for black pixels, different ranges may be set. Furthermore, such ranges may be set for white pixels rather than black pixels. Furthermore, while at S905 and S906 amplifier 204 has a gain adjusted in level by 1 db at a time, amplifier 204 may have a gain adjusted in level otherwise.

Herein amplifier 204 can have a gain adjusted in level, i.e., gain control terminal 214 can have voltage adjusted in level, simply by additionally introducing a simple circuit formed of constant voltage source VCC and variable resistor 206, and hence inexpensively. If A/D converted image data 208 is similarly adjusted, then a load of CPU 103 that is associated with an image data process is increased and the authentication process including comparison is effected at a reduced rate. Amplifier 204 having a gain adjusted in level can eliminate such disadvantage.

Furthermore, amplifier 204 can have a gain adjusted in an amount that can be determined in accordance with image quality, i.e., incremented or decremented by 1 db. Appropriate image quality can rapidly be achieved.

As shown in FIG. 10, non-volatile memory 105 has stored therein only one enrolled fingerprint data 107 for the authentic owner of mobile phone 600. Enrolled fingerprint data 107 includes gain control level data 121, which indicates a level in gain of amplifier 204 applied to pick up an image of a fingerprint of fingerprint image data 122 of enrolled fingerprint data 107. In the fingerprint authentication process described hereinafter gain control signal 205 having a level set as based on gain control level data 121 is employed to pick up an image of a fingerprint.

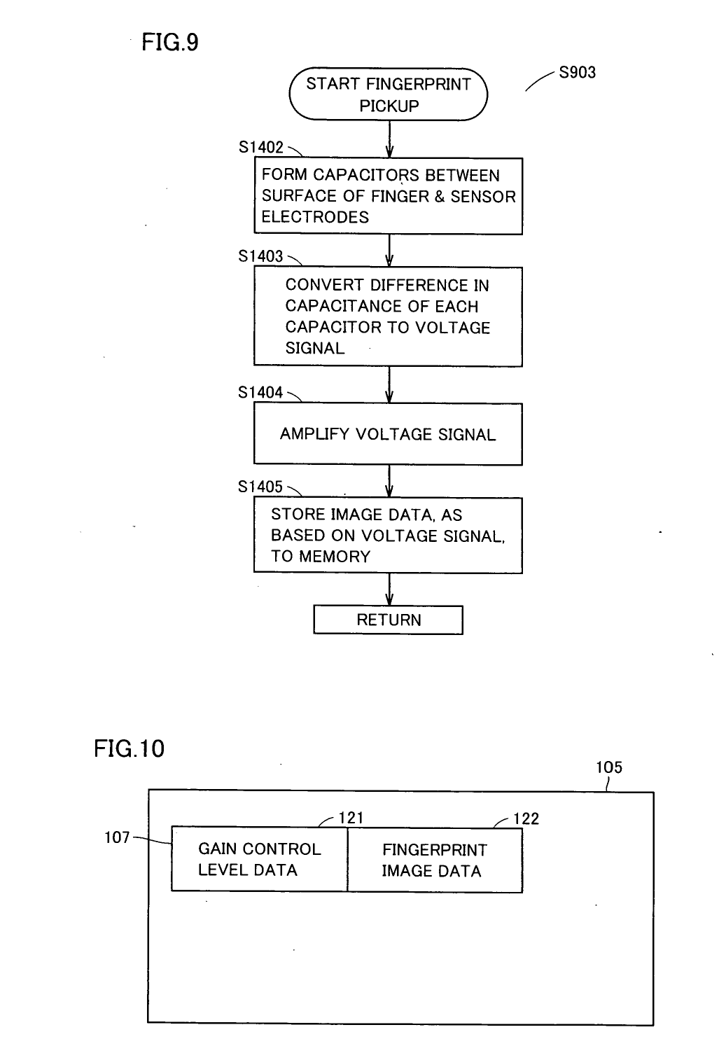

The S903 fingerprint pickup process will now be described with reference to the FIG. 9 flow chart.

Initially at S1402 finger 301 is placed on pickup surface 201 and between each sensor electrode 202 and a surface of finger 301 each capacitor 302 is formed. At S1403 sensor circuit 203 detects a difference in capacitance of each capacitor 302 and converts a result of the detection to a voltage signal. At S1404 amplifier 204 receives the voltage signal from sensor circuit 203 and amplifies the voltage signal. The voltage signal amplified at S1404 is converted at S1405 by A/D converter 207 to digital data, or image data 208, and thus output. Thus image data 208 picked up and thus output is stored via CPU 103 to main memory 106. CPU 103 then returns to the FIG. 8 process. Thus whenever image data 208 is output and stored to main memory 106, picking up an image completes.

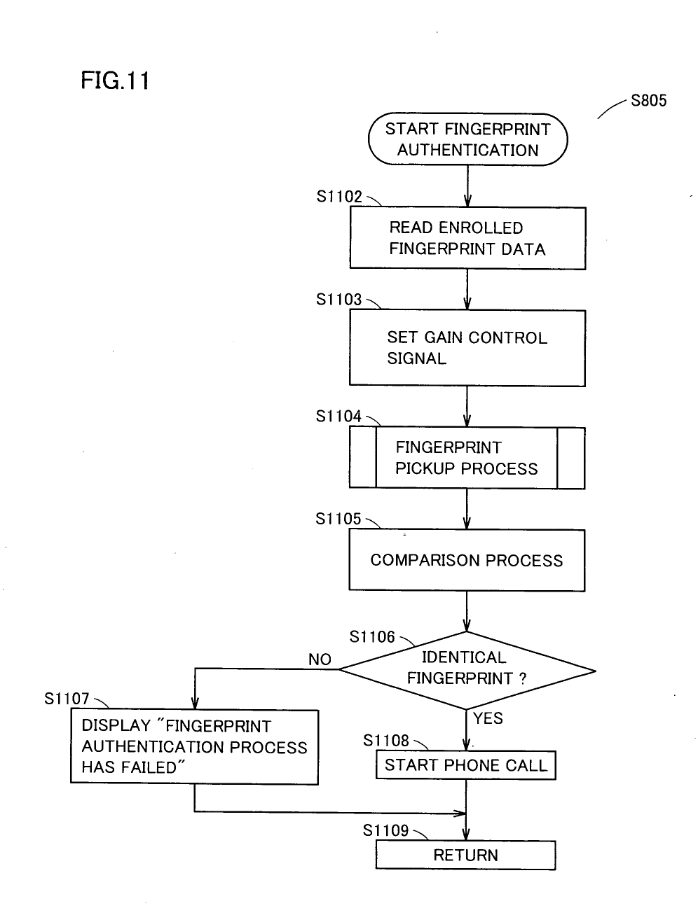

The fingerprint authentication process indicated in FIG. 7 at S805 will now be specifically described with reference to the FIG. 11 flow chart. Non-volatile memory 105 has previously stored therein for the sake of illustration enrolled fingerprint data 107 of an enrolled person or an authentic owner of mobile phone 600. Furthermore on pickup surface 201 finger 301 is placed for the sake of illustration.

At S1102 CPU 103 reads enrolled fingerprint data 107 from non-volatile memory 105 and stores the read, enrolled fingerprint data 107 to main memory 106.

Then at S1103 CPU 103 reads gain control level data 121 included in enrolled fingerprint data 107 stored in main memory 106, and sets gain control signal 205 to have a level indicated by the read gain control level data 121 and outputs to variable resistor 206 the gain control signal 205 thus set in level. Accordingly movable piece 210 moves to a position on a resistive element in accordance with the level of gain control signal 205, and amplifier 204 has a gain set to be the same as in picking up fingerprint image data 122 of enrolled fingerprint data 107.

Subsequently CPU 103 proceeds to S1104 to effect a fingerprint pickup process, similarly as done in FIG. 8 at S903. When the fingerprint pickup process completes, main memory 106 receives and stores picked up and thus output image data 208 therein.

Then at S1105 the comparison process is effected. CPU 103 compares the currently picked up image data 208 read from main memory 106 with fingerprint image data 122 of enrolled fingerprint data 107 read from main memory 106 to determine whether the two fingerprint image data are identical fingerprint data.

A general method employed to perform the comparison process is minutia matching as described for example in Japanese Patent Laying-Open No. 2001-243465. As described in the publication, minutia matching extracts from a fingerprint's image the end point, bifurcation point, and the like (hereinafter referred to as minutia) and compares a minutia of an enrolled fingerprint image with that present in a fingerprint image to be compared. Note that the comparison process may be effected in a different method. For example, it may utilizes a direction of a ridge of a fingerprint, as described specifically in Japanese Patent Laying-Open No. 05-108805.

At S106 the process branches in accordance with a result of the 1105 comparison process. More specifically, if the S1105 comparison process determines that the two compared fingerprint images are not identical, i.e., the fingerprint authentication process fails, then the process branches to S1107. If a decision is made that the two fingerprint images are identical, i.e., the fingerprint authentication process is successfully done, the process branches to S1108. At S1107 the fingerprint authentication process fails and CPU 103 accordingly causes display 104 to display “fingerprint authentication process has failed”. At S1108 the fingerprint authentication process is successfully done, and CPU 103 permits a phone call function of mobile phone 600 to be used, and the phone call process starts. After the FIG. 11 process ends, CPU 103 returns to the FIG. 7 process.

For the sake of illustration, persons to be authenticated having dry skin, wearing a rubber glove for falsification and the like cause mobile phone 600 having fingerprint image data 122 of a person having oily skin enrolled therein to perform the fingerprint authentication process to authenticate their fingerprints. Even if in the fingerprint authentication process image data 208 of the fingerprint of the person wearing the rubber glove for falsification is identical to a pattern of a fingerprint of fingerprint image data 122 of an authentic, enrolled person, the S1104 fingerprint pickup process cannot extract a minutia from image data 208 obtained from the falsified fingerprint, since at S103 gain control signal 205 is set in level to match the enrolled person having oily skin. Thus the fingerprint authentication process based on the S1105 comparison process fails. Finger authentication apparatus 1 can thus provide a reduced FAR and enhance security in connection with using mobile phone 600 having fingerprint authentication apparatus 1 mounted therein.

### Second Embodiment

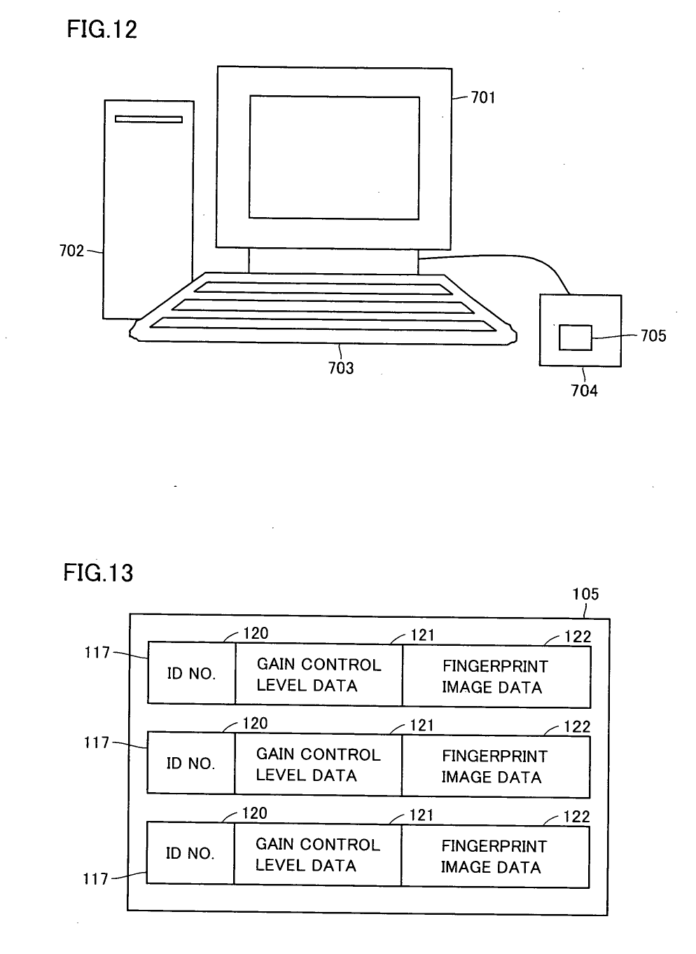

In contrast to mobile phone 600, the present embodiment assumes that fingerprint authentication apparatus 1 is mounted in equipment shared by a plurality of persons, such as a server computer shown in FIG. 12. Accordingly, it has fingerprint image data of a plurality of enrolled persons enrolled therein.

With reference to FIG. 12 the server computer includes a liquid crystal display 701 corresponding to display 104, a keyboard 703 corresponding to input device 102, a fingerprint pickup 704 corresponding to fingerprint pickup 101, and a main body 702 of the server computer. Fingerprint pickup 704 has a pickup surface 705 corresponding to pickup surface 201. Main body 702 has the FIG. 1 CPU 103, non-volatile memory 105, main memory 106, external I/F 109 and communication I/F 112.

Note that the server computer is set to require fingerprint authentication in logging in the server computer and only when the fingerprint authentication is successfully done, logging in the server computer is permitted for the sake of illustration.

In the present embodiment non-volatile memory 105 does not store enrolled fingerprint data 107 shown in FIG. 10. Rather, as shown in FIG. 13, it stores enrolled fingerprint data 117 corresponding to a plurality of enrolled persons, respectively, previously authorized to log in the server computer. Each enrolled fingerprint data 117 includes ID number data 120, gain control level data 121 and fingerprint image data 122 for uniquely identifying an enrolled person corresponding thereto.

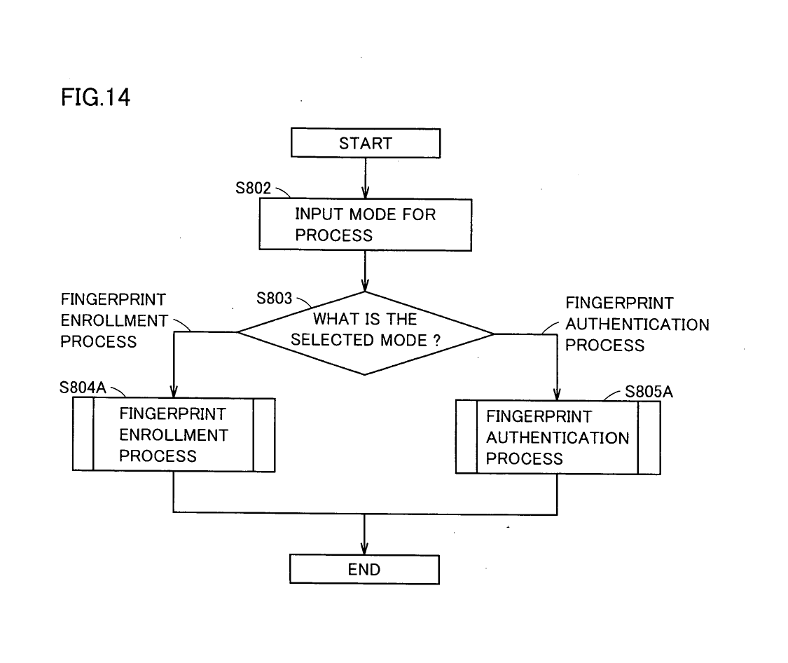

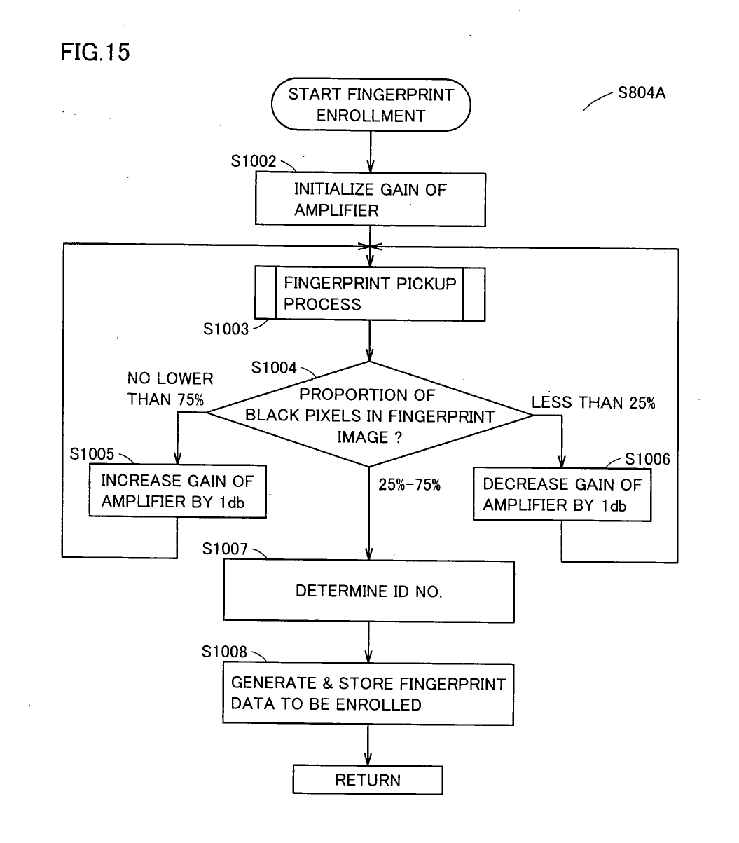

The present embodiment provides a process having a procedure generally as shown in FIG. 14. The FIG. 14 procedure is identical to FIG. 7 except that the FIG. 7 S804 and S805 are replaced with S804A and S805A, respectively. In accordance with the present embodiment a fingerprint enrollment process indicated in FIG. 14 at S804A has a procedure, as will be described hereinafter with reference to FIG. 15.

The FIG. 15 S1002-S1006 are identical to the FIG. 8 S902-S906. In FIG. 15 at S1007 and S1008 CPU 103 operates to generate and store enrolled fingerprint data 117 to non-volatile memory 105. In generating enrolled fingerprint data 117 CPU 103 sets ID number data 120 to have a value indicating the number of enrolled fingerprint data 117 currently stored in non-volatile memory 105. The FIG. 15 procedure is repeated a number of times corresponding to the number of enrolled fingerprint data 117 enrolled in non-volatile memory 105. Whenever the FIG. 15 process ends, CPU 103 returns to the FIG. 14 process.

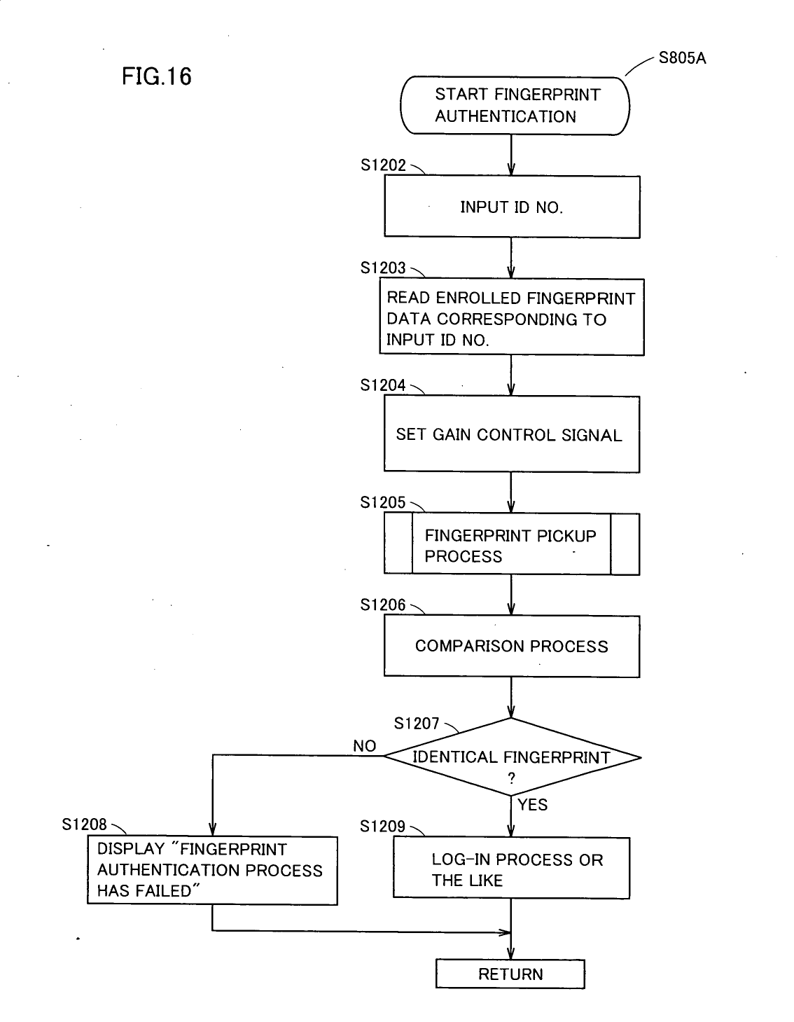

The S805A fingerprint authentication process will be described with reference to the FIG. 16 procedure. For the sake of illustration, a user of the computer server (or an enrolled person) previously recognizes ID number data 120 of enrolled fingerprint data 117 corresponding to him/her. Furthermore for the sake of illustration finger 301 of a person to be authenticated is placed on pickup surface 201.

Initially CPU 103 receives ID number data input at S1202 by a user as a person to be authenticated operating keyboard 703 corresponding to input device 102. At S1203 CPU 103 searches non-volatile memory 105 based on the ID number data input at S1202. Namely, CPU 103 reads from non-volatile memory 105 and stores to main memory 106 enrolled fingerprint data 117 having ID number data 120 matching the ID number data input at S1202.

At S1204 CPU 103 performs the S1204-S1206 steps as based on enrolled fingerprint data 117 of main memory 106 and image data 208 received via fingerprint pickup 704 corresponding to fingerprint pickup 101. The S1204-S1206 steps are identical to the FIG. 11 S1103-S1105 steps.

At S1207 the process branches in accordance with a result of the comparison process performed at S1206. If the S1206 comparison process provides a result indicating that two compared fingerprint image data are not identical fingerprint images then the fingerprint authentication process fails and the process branches to S1208. Otherwise, the fingerprint authentication process is successfully done and the process branches to S1209. At S1208 the fingerprint authentication process fails and CPU 103 accordingly display “fingerprint authentication process has failed” by display 701 corresponding to display 104. At S1209 the fingerprint authentication process is successfully done, and CPU 103 performs a process for logging in the server computer, or the like. After the FIG. 16 process ends CPU 103 returns to the FIG. 14 process.

In the present embodiment, as well as the first embodiment, if a person to be authenticated wearing a rubber glove or the like uses a thus falsified fingerprint's image data to cause a server computer having fingerprint image data of a person having oily skin enrolled therein to perform a fingerprint authentication process based on the S1206 comparison process, the fingerprint authentication process fails.

Furthermore if the server computer has stored in non-volatile memory 105 enrolled fingerprint image data 117 of enrolled persons having oily skin and dry skin, respectively, enrolled fingerprint data 117 with ID number data 120 of “1” has fingerprint image data 122 of the enrolled person having oily skin and enrolled fingerprint data 117 with ID number data 120 of “2” has fingerprint image data 122 of the enrolled person having dry skin, and a user (or enrolled person) assigned “2” as ID number data 120 undergoes the fingerprint authentication process and the user inputs “1” as an ID number at S1202, then in S1204, in response to the input ID number (or “1”) gain control signal 205 is set to have a level that matches a fingerprint of oily skin. In the S1205 fingerprint pickup process a fingerprint is picked up, and with a gain inappropriate in level, fingerprint image data 208 allowing a minutia to be extracted cannot be obtained and the fingerprint authentication process based on the S1206 comparison process fails. Finger authentication apparatus 1 can thus provide a reduced FAR and enhance security in connection with logging in the server computer having fingerprint authentication apparatus 1 incorporated therein.

### Third Embodiment

In the present embodiment, as well as the second embodiment, will be described a fingerprint authentication process provided when authentication process apparatus 1 is mounted in the FIG. 12 server computer. In contrast to the second embodiment the present embodiment does not require inputting ID number data in the fingerprint authentication process.

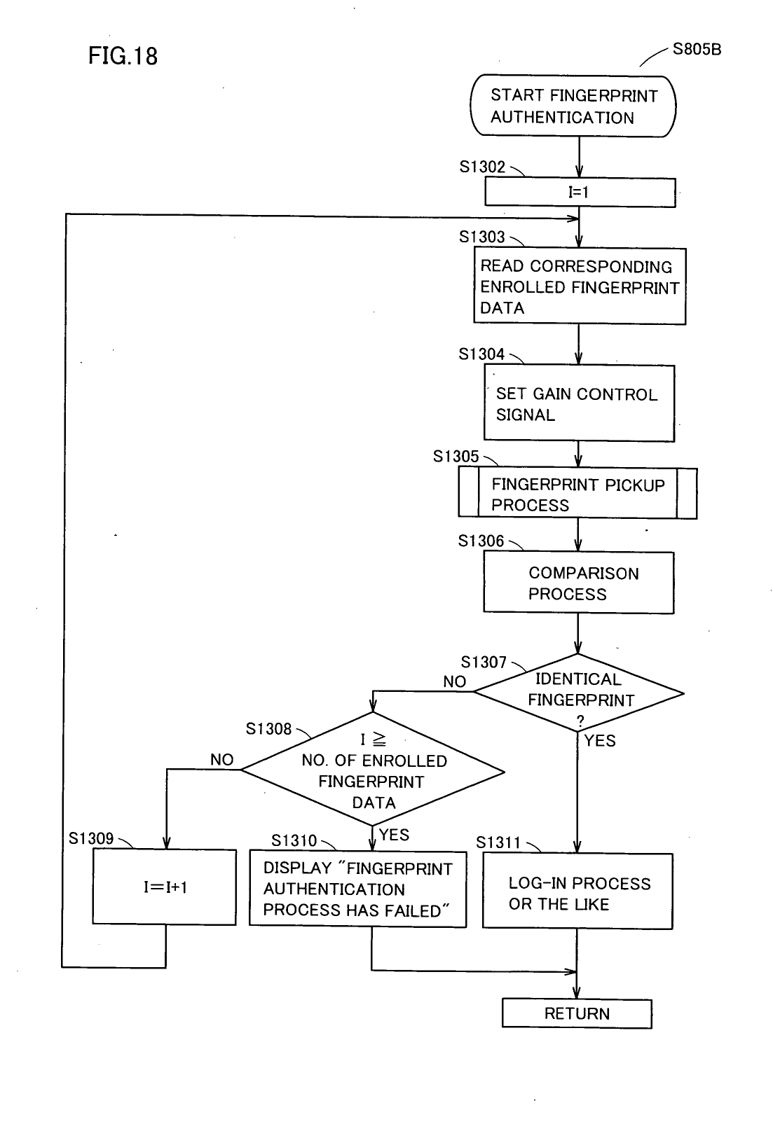

The present embodiment provides a process generally similar to the second embodiment indicated in FIG. 14 except that S805A is replaced with S805B. In accordance with the present embodiment a fingerprint authentication process performed at S805B has a procedure, as will be described hereinafter with reference to FIG. 18.

For the FIG. 18 fingerprint authentication process non-volatile memory 105 has enrolled fingerprint data 117 of a plurality of enrolled persons, as shown in FIG. 13, previously stored therein for the sake of illustration. Furthermore, for the sake of illustration, finger 301 of a person to be authenticated is placed on pickup surface 201.

Initially at S1302 CPU 103 sets “1” as an initial value for a temporary variable I for indicating ID number data 120. Subsequently at S1303 CPU 103 searches non-volatile memory 105 to retrieve enrolled fingerprint data 117 having ID number data 120 indicating the value of variable I, and reads and stores enrolled fingerprint data 117 to main memory 106.

Through S1304-S1306 CPU 103 employs enrolled fingerprint data 117 of main memory 106 and image data 208 of a person to be authenticated received via fingerprint pickup 101 to effect a comparison process. The pickup process and the comparison process are performed in a procedure similar to S103-S1105.

At S1307 the process branches in accordance with a result of the comparison process performed at S1306. If CPU 103 determines that the S1306 comparison process provides a result indicating that the two compared fingerprint image data do not indicate identical fingerprint images then the process branches to S1308. Otherwise, the fingerprint authentication process is successfully done and the process branches to S1311. If the process branches to S1308 CPU 103 determines whether there is any enrolled fingerprint data 117 stored in non-volatile memory 105, as shown in FIG. 13, that that is uncompared. More specifically, at S1308 CPU 103 compares the current variable I value with the total number of enrolled fingerprint data 117 stored in non-volatile memory 105 and if the former is smaller than the latter then the process branches to S1309, otherwise the process branches to S1310.

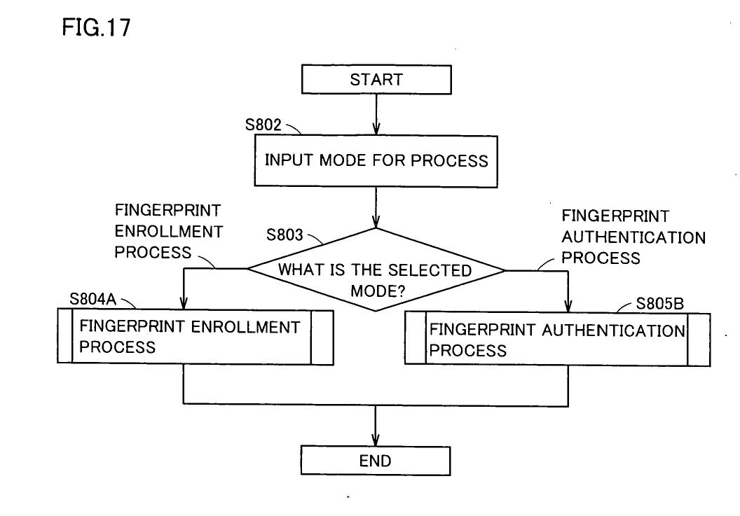

If the process branches to S1309, non-volatile memory 105 has uncompared enrolled fingerprint data 117. Accordingly at S1309 CPU 103 increments variable I by one and returns to S1303 and thereafter similarly continues the fingerprint authentication process for subsequent enrolled fingerprint data 117. If the process branches to S1310, it means that while non-volatile memory 105 have enrolled fingerprint data 117 all compared, the S1307 decision indicates that the fingerprint is not an identical fingerprint, i.e., a fingerprint of a person to be authenticated input at S1305 does not match any of fingerprints indicated by enrolled fingerprint data 117 stored in non-volatile memory 105. Accordingly CPU 1303 causes display 701 corresponding to display 104 to display the massage “fingerprint authentication process has failed”. At S1311 the fingerprint authentication process is successfully done, and CPU 103 performs a process for logging in the server computer, or the like. After the FIG. 18 process ends, CPU 103 returns to the FIG. 17 process.

For the sake of illustration a person to be authenticated wearing a rubber glove or the like for falsification causes a server computer having enrolled fingerprint data 117 of an enrolled person having oily skin enrolled in non volatile memory 105 to perform the fingerprint authentication process. In that case in the fingerprint authentication process at S1304 gain control signal 205 is set to have a level that matches a fingerprint of oily skin. As such, even if the person wearing the rubber glove for falsification provides fingerprint image data having a pattern identical to that of fingerprint image data of an enrolled person, the S1305 fingerprint pickup process cannot provide image data 208 allowing a minutia to be extracted therefrom, and the S1306 comparison process comparison process fails.

Furthermore if the server computer has stored in non-volatile memory 105 enrolled fingerprint image data 117 of enrolled persons having oily skin and dry skin, respectively, enrolled fingerprint data 117 with ID number data 120 of “1” indicates data of the enrolled person having oily skin and enrolled fingerprint data 117 with ID number data 120 of “2” indicates data of the enrolled person having dry skin, and the enrolled person assigned “2” as ID number data 120 undergoes the fingerprint authentication process, then initially at S1304 gain control signal 205 is set to have a level to match a fingerprint associated with ID number data 120 of “1”, i.e., a process performed to authenticate a fingerprint associated with oily skin. The S1305 fingerprint pickup process cannot provide image data 208 allowing a minutia to be extracted therefrom and the fingerprint authentication process based on the S1306 comparison process fails. The process branches from S1307 to S1308, S1309, and returns to S1303. Subsequently at S1304 gain control signal 205 is set to have a level to match a fingerprint associated with ID number data 120 of “2”, i.e., a process performed to authenticate a fingerprint associated with dry skin. The S1305 fingerprint pickup process can provide image data 208 allowing a minutia to be extracted therefrom, and the fingerprint authentication process based on the S1306 comparison process is successfully done.

Thus an enrolled person is not required to input an ID number subjected to an authentication process and instead only required to place his/her finger 301 on pickup surface 201. Picked up image data 208 can be compared with fingerprint image data 122 of enrolled fingerprint data 117 corresponding to the enrolled person and successful fingerprint authentication can thus be provided.

Finger authentication apparatus 1 can thus provide a reduced FAR and thus enhance security in connection with logging in the server computer having fingerprint authentication apparatus 1 incorporated therein.

### Fourth Embodiment

The above described process function is implemented by a program. In the present embodiment this program is stored in a computer readable storage medium.

In the present embodiment, as this storage medium a memory required by the FIG. 1 authentication processor 1 to perform a process, such as main memory 106 itself, may be a program medium or it may be a program medium that is readable as a storage medium in the form of magnetic tape or CD-ROM 111 is inserted in a program reader, such as a magnetic tape device and a CD-ROM device (not shown) provided as external I/F 109. In either case, the stored program may be configured such that CPU 103 accesses and executes it, or in either case the program may once be read and loaded in the FIG. 1 apparatus at a prescribed program storage area, for example into main memory 106 at a program storage area, and read and executed by CPU 103. The program to be loaded is previously stored in authentication processor 1 for the sake of illustration.

The above described program medium is a storage medium configured to be separable from the main body of authentication processor 1 and may be magnetic tape, cassette tape or similar tape, FD 110, a hard disk or a similar magnetic disk, a CD-ROM 111/magnetic optical (MO) disc, mini disc (MD)/digital versatile disc (DVD) or a similar optical disk, and an IC card (including a memory card)/an optical card or a similar card, or mask ROM, erasable and programmable ROM (EPROM), electrically EPROM (EEPROM), flash ROM or a similar medium including semiconductor memory and carrying a fixed program.

Furthermore in the present embodiment authentication processor 1 is configured to be connectable via communication network 113 including the Internet and communication I/F 112. Accordingly the medium may be a medium carrying a program in a state of flux so as to download the program from communication network 113. If the program is downloaded from communication network 113, the program may previously be stored in the main body of authentication processor 1 or installed previously from a different storage medium to the main body of authentication processor 1.

Note that the storage medium may have not only a program but also data stored therein.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An authentication apparatus comprising:
a pickup operative in accordance with a parameter value received to pick up an image of an object and outputting an image signal of said object;
a converter converting said image signal to image data and outputting said image data;
a parameter determinator operative in an enrollment mode in accordance with said image data to determine said parameter value;
a storage storing said parameter value determined by said parameter determinator and said image data output from said converter in association with each other; and
a comparison controller operative in an authentication mode to read said parameter value from said storage and output read said parameter value to said pickup, and compare said image data associated with said parameter value read from said storage with said image data output from said converter.

2. The authentication apparatus according to claim 1, wherein:
said parameter determinator includes:
an image quality determinator determining in accordance with a prescribed level for said comparison an image quality level indicated by said image data output from said converter; and
a parameter adjuster adjusting said parameter value and outputting to said pickup said parameter value adjusted, wherein until said image quality determinator determines that said image quality level matches said prescribed level, said pickup's picking up, said converter's data conversion, said image quality determinator's determination on image quality, and said parameter adjuster's adjustment of said parameter value are repeated.

3. The authentication apparatus according to claim 2, wherein said parameter adjuster adjusts said parameter value in accordance with a result of said determination made by said image quality determinator.

4. The authentication apparatus according to claim 1, wherein said pickup includes a brightness modifier modifying in accordance with said parameter value received a level in brightness of said object indicated by said image signal.

5. The authentication apparatus according to claim 4, wherein said brightness modifier receives said image signal and modifies a direct current component of received said image signal in level in accordance with said parameter received.

6. The authentication apparatus according to claim 4, wherein said brightness modifier modifies in accordance with said parameter value received a quantity of light illuminating said object in picking up said image of said object.

7. The authentication apparatus according to claim 1, wherein:
said image data indicates binary data; and
said converter receives said image signal and converts received said image signal to binary data in accordance with a level in brightness of said received image signal.

8. The authentication apparatus according to claim 7, wherein:
said image data indicates said binary data allowing each pixel to correspond to one of a black pixel and a white pixel; and
said prescribed level is indicated by a proportion of pixels of one of said black 5 pixel and said white pixel relative to all pixels of said image data.

9. The authentication apparatus according to claim 1, wherein said object is a fingerprint.

10. A method of authentication effected by a computer performing an authentication process based on a result of comparing image data, comprising the steps of:
employing a pickup in accordance with a parameter value received to pick up an image of an object and output an image signal of said object;
receiving and converting said image signal to image data for output;
in an enrollment mode, determining said parameter value in accordance with said image data output at the step of converting;
storing said parameter value determined at the step of determining and said image data output at the step of converting in association with each other; and
in an authentication mode, reading said parameter value from said storage and outputting said read parameter value to said pickup, and comparing said image data associated with said parameter read from said storage with said image data output at the step of converting.

11. A machine readable storage device storing instruction executable by said computer to perform the method of claim 10.

12. A program product causing a computer to perform a method of authentication, comprising:
computer readable first program code means for causing said computer to operate in accordance with a parameter value received to use a pickup to pick up an image of an object and output an image signal of said object;
computer readable second program code means for causing said computer to convert to image data said image signal output by said computer readable first program code means, and output said image data;
computer readable third program code means for causing said computer in an enrollment mode to determine said parameter value as based on said image data output by said computer readable second program code means;
computer readable fourth program code means for causing said computer to associate said parameter value determined by said computer readable third program code means with said image data output by said computer readable second program code means and thus store said parameter value and said image data to a storage; and
computer readable fifth program code means for causing said computer in an authentication mode to read said parameter value from said storage and output said read parameter value to said pickup, and compare said image data associated with said parameter value read from said storage with said image data output by said computer readable second program code means.
